(19) United States
(12) Patent Application Publication
(10) Pub. No.: US 2016/0313667 A1
(43) Pub. Date: Oct. 27, 2016

(54) DEVELOPING DEVICE

(71) Applicant: FUJI XEROX CO., LTD., Tokyo (JP)

(72) Inventors: Tomoyuki YOSHII, Kanagawa (JP); Yasuaki WATANABE, Kanagawa (JP); Jun ABE, Kanagawa (JP); Toshihiro KANEMATSU, Kanagawa (JP); Takashi OCHI, Kanagawa (JP); Kenta URAYAMA, Kanagawa (JP); Shinji OKUYAMA, Kanagawa (JP); Fumiyuki HONDA, Kanagawa (JP)

(21) Appl. No.: 14/925,200

(22) Filed: Oct. 28, 2015

(30) Foreign Application Priority Data
Apr. 22, 2015 (JP) 2015-087955

(51) Int. Cl. G03G 15/09

(52) U.S. Cl. CPC G03G 15/0812; G03G 15/0808

(57) ABSTRACT

Provided is a developing device, including a developer holding member that is rotatably disposed with opposing a latent image holding member which holds an electrostatic latent image, holds a developer including a toner and a carrier which include a conductive metallic pigment and are charged as normal polarity set in advance, is imparted with a potential of a same polarity as the normal polarity, and develops the electrostatic latent image with the toner, and an opposing member that is disposed with opposing the developer holding member at a position different from a position of the latent image holding member, and is imparted with a potential having a same polarity as the normal polarity, and has an absolute value greater than an absolute value of the potential of the developer holding member.

### CROSS-REFERENCE TO RELATED APPLICATIONS

This application is based on and claims priority under 35 USC 119 from Japanese Patent Application No. 2015-087955 filed Apr. 22, 2015.

### BACKGROUND

### Technical Field

The present invention relates to a developing device.

### SUMMARY

According to an aspect of the invention, there is provided a developing device, including:

a developer holding member that is rotatably disposed with opposing a latent image holding member which holds an electrostatic latent image, holds a developer including a toner and a carrier which include a conductive metallic pigment and are charged as normal polarity set in advance, is imparted with a potential of a same polarity as the normal polarity, and develops the electrostatic latent image with the toner; and

an opposing member that is disposed with opposing the developer holding member at a position different from a position of the latent image holding member, and is imparted with a potential having a same polarity as the normal polarity, and has an absolute value greater than an absolute value of the potential of the developer holding member.

### BRIEF DESCRIPTION OF THE DRAWINGS

Exemplary embodiments of the present invention will be described in detail based on the following figures, wherein:

FIG. 1 is a view illustrating the entire configuration of an image forming apparatus in which an exemplary embodiment is employed;

FIG. 2 is a view illustrating a configuration example of a developing device in which the exemplary embodiment is employed;

FIG. 3 is a view illustrating charged quantity distribution of a toner of metallic color on a developer layer formed on a developing sleeve;

FIG. 4 is a view illustrating an action caused by a charge supply bias;

FIG. 5 is a view illustrating a configuration example of the developing device in which a second exemplary embodiment is employed; and

FIGS. 6A to 6B are views illustrating charged quantity distribution of a toner captured by a seal roll.

### DETAILED DESCRIPTION

### First Exemplary Embodiment

Hereinafter, an exemplary embodiment of the present invention will be described in detail with reference to the attached drawings.

Entire Configuration of Image Forming Apparatus

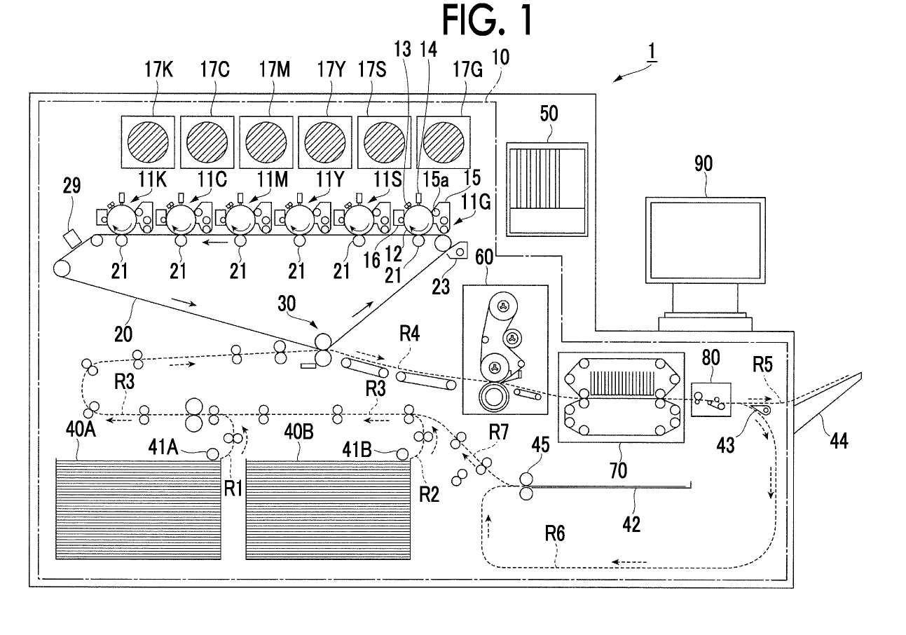

FIG. 1 is a view illustrating the entire configuration of an image forming apparatus 1 in which the exemplary embodiment is employed.

The image forming apparatus 1 illustrated in FIG. 1 is a so-called “tandem type” color printer, and includes an image forming portion 10 which performs image forming based on image data; a main control portion 50 which is an example of a control unit that performs operation control of the entire image forming apparatus 1, communication with a personal computer (PC) or the like, and image processing or the like with respect to the image data; and a user interface (UI) portion 90 which receives an operation input from a user, and performs display of various types of information with respect to the user.

The image forming portion 10 is a functional portion which forms an image, for example, by an electrophotographic system, and includes six image forming units 11G, 11S, 11Y, 11M, 11C, and 11K (hereinafter, there is a case where all of the image forming units are referred to as an image forming unit 11) which are disposed in parallel.

Among these, each of the image forming units 11Y, 11M, 11C, and 11K forms yellow (Y), magenta (M), cyan (C), and black (K) toner images. In contrast to this, each of the image forming units 11G and 11S forms gold (G) and silver (S) toner images. In addition, in the description below, each of the yellow, magenta, cyan, and black colors is referred to as an ordinary color, and each of the gold and silver colors that are colored by a metallic pigment is referred to as a metallic color.

In addition, in the image forming apparatus 1 of the exemplary embodiment, a full-color image which uses the toner of the ordinary color, that is, yellow, magenta, cyan, and black colors, is formed, and a full-color image on which an image that shows the metallic color that uses the gold and/or silver toner is further superposed is also formed.

Each of the image forming units 11 includes a photosensitive drum 12 which is an example of a latent image holding member provided to be rotatable in a direction illustrated by an arrow in the drawing. In addition, each of the image forming units 11 includes a charging member 13, an exposure device 14, a developing device 15, and a drum cleaner 16, which are provided along the arrow direction around the photosensitive drum 12.

The photosensitive drum 12 includes an organic photosensitive layer (not illustrated) formed on a front surface of a thin cylindrical drum made of metal, and here, the organic photosensitive layer is configured of a material which is charged as negative polarity. In addition, the photosensitive drum 12 is grounded.

The charging member 13 charges the front surface (organic photosensitive layer) of the photosensitive drum 12 to a negative potential set in advance. For this reason, a charging bias for charging the photosensitive drum 12 to a negative potential is applied to the charging member 13.

The exposure device 14 forms an electrostatic latent image by selectively performing optical writing by using laser light or the like, on the photosensitive drum 12 which is charged as a negative potential by the charging member 13. Here, the exposure device 14 of the exemplary embodiment performs exposure by a so-called image portion exposing method which irradiates a part (image portion) which becomes a toner image (image) with light, and does not irradiate a part (background portion) which becomes a background. In addition, as a light source in the exposure device 14, it is possible to use a light emitting diode (LED) light source, in addition to the laser light source.

The developing device 15 includes a developing roll 15a which is disposed to be rotatable opposing the photosensitive drum 12, and a developer which includes a toner of a color set in advance is accommodated inside the developing device 15. Here, in the developing device 15 of the exemplary embodiment, as the developer, a so-called two-component developer which includes a magnetic carrier and a toner colored to have a color set in advance, is used. In addition, in the developer, the carrier has a positive charging polarity, and the toner has a negative charging polarity.

The developing roll 15a has a magnet (not illustrated) embedded therein, and holds the carrier, that is, the developer which makes the toner attached by an electrostatic force, on a front surface of the developing roll 15a by a magnetic force. In the developing device 15, a magnetic brush which is formed by the developer held on the developing roll 15a is brought into contact with the photosensitive drum 12, and the electrostatic latent image on the photosensitive drum 12 is developed by the toner. As the developing device 15 supplies developing bias for charging the developing roll 15a to a negative potential, the developing is performed by a so-called reversal development method which transfers the toner charged as negative polarity, to the image portion charged as negative polarity among the electrostatic latent images.

In addition, a configuration of the developing device 15 will be described in detail hereinafter.

The drum cleaner 16 cleans the front surface of the photosensitive drum 12 after the transfer (primary transfer).

In addition, each developing device 15 of each image forming unit 11 is linked to toner storage containers 17G, 17S, 17Y, 17M, 17C, and 17K (hereinafter, there is a case where all of toner storage containers are referred to as a toner storage container 17) which store toners of colors corresponding to each of the developing devices 15 by a toner transporting path (not illustrated). In addition, by a replenishment screw (not illustrated) provided in the middle of the toner transporting path, the toners of each color are configured to be replenished to the developing device 15 from the toner storage container 17.

In addition, the image forming portion 10 includes an intermediate transfer belt 20 on which the toner images of each color formed on the photosensitive drums 12 of each of the image forming units 11 are transferred, and a primary transfer roll 21 which transfers (primarily transfers) the toner images of each color formed by each of the image forming units 11 to the intermediate transfer belt 20. Furthermore, the image forming portion 10 includes a secondary transfer portion 30 which collectively transfers (secondarily transfer) the toner images of each color that are superposed and transferred onto the intermediate transfer belt 20 to a paper sheet which is a transfer medium (recording material).

The intermediate transfer belt 20 is an example of a holding member, and is configured of a film-shaped endless belt which allows a resin, such as polyimide or polyamide, to contain an appropriate amount of conductive material, such as a carbon black or the like. The intermediate transfer belt 20 is driven to be circulated (rotated) at a speed set in advance in the arrow direction illustrated in FIG. 1 by various rolls (not illustrated).

Furthermore, the image forming portion 10 includes a belt cleaner 23 which cleans the front surface of the intermediate transfer belt 20 after transferring (secondary transferring), and a fixing machine 60 which fixes the secondarily transferred toner images of each color onto the paper sheet. In addition, the image forming portion 10 includes a condenser 70 which cools the toner images of each color fixed onto the paper sheet by the fixing machine 60, and accelerates fixing of the toner images of each color onto the paper sheet, and a curl correction device 80 which corrects curve (curl) of the paper sheet.

In addition, the image forming portion 10 includes plural (two in the exemplary embodiment) paper sheet accommodation containers 40A and 40B which accommodate the paper sheet, feeding rolls 41A and 41B which feed and transport the paper sheet accommodated in the paper sheet accommodation containers 40A and 40B, a first transporting path R1 which transports the paper sheet from the paper sheet accommodation container 40A, and a second transporting path R2 which transports the paper sheet from the paper sheet accommodation container 40B, as a paper sheet transporting system. Furthermore, the image forming portion 10 includes a third transporting path R3 which transports the paper sheet from the paper sheet accommodation container 40A and the paper sheet accommodation container 40B to the secondary transfer portion 30. In addition, the image forming portion 10 includes a fourth transporting path R4 which transports the paper sheet to which the toner images of each color are transferred by the secondary transfer portion 30 to pass through the fixing machine 60, the condenser 70, and the curl correction device 80, and a fifth transporting path R5 which transports the paper sheet from the curl correction device 80 to a paper sheet loading portion 44 provided on the outside of the image forming apparatus 1.

On the first transporting path R1 and the fifth transporting path R5, a transporting roll or a transporting belt which sequentially transports the paper sheet is disposed along each of the first transporting path R1 and the fifth transporting path R5.

In addition, the image forming portion 10 includes an intermediate paper sheet accommodation container 42 which temporarily holds the paper sheet to which the toner images of each color are fixed on a first surface by the fixing machine 60 as a duplex transporting system, a sixth transporting path R6 which transports the paper sheet from the curl correction device 80 to the intermediate paper sheet accommodation container 42, and a seventh transporting path R7 which transports the paper sheet accommodated in the intermediate paper sheet accommodation container 42 to the above-described third transporting path R3. Furthermore, the image forming portion 10 includes a sorting mechanism portion 43 which is disposed on a downstream side in a transporting direction of the paper sheet of the curl correction device 80, and selectively sorts the paper sheet to the fifth transporting path R5 which transports the paper sheet to the paper sheet loading portion 44, and the sixth transporting path R6 which transports the paper sheet to the intermediate paper sheet accommodation container 42, and a feeding roll 45 which feeds the paper sheet accommodated in the intermediate paper sheet accommodation container 42, and transports the paper sheet to the seventh transporting path R7.

Regarding Image Forming Operation

Next, a basic image forming operation which is performed in the image forming apparatus 1 in which the exemplary embodiment is employed will be described.

Each of the image forming units 11 of the image forming portion 10 forms the toner images of each color, such as G color, S color, Y color, M color, C color, and K color by an electrophotographic process. For example, in the image forming unit 11K which forms a black (K) toner image, the photosensitive drum 12 is charged as a potential set in advance by the charging member 13 while the photosensitive drum 12 rotates in the arrow direction, and the exposure device 14 makes the photosensitive drum 12 scanned and exposed based on black (K) image data. Accordingly, the electrostatic latent image related to the black (K) image is formed on the photosensitive drum 12. The black (K) electrostatic latent image formed on the photosensitive drum 12 is developed by the developing device 15, and the black (K) toner image is formed on the photosensitive drum 12. Similarly, in the image forming units 11G, 11S, 11Y, 11M, and 11C, the toner images of each color, such as gold (G), silver (S), yellow (Y), magenta (M), and cyan (C), are formed.

The toner images of each color formed by each image forming unit 11 are sequentially primarily transferred onto the intermediate transfer belt 20 by each primary transfer roll 21, and a full-color toner image made by superposing the toner images of each color is formed. The full-color toner image on the intermediate transfer belt 20 is transported to the secondary transfer portion 30 according to the movement (in the arrow direction) of the intermediate transfer belt 20.

Meanwhile, in the paper sheet transporting system, the feeding rolls 41A and 41B are operated to be rotated in accordance with the initiating timing of image forming in each image forming unit 11, and the paper sheet which is appointed, for example, by the UI portion 90 from the paper sheet accommodation container 40A and the paper sheet accommodation container 40B is fed by the feeding rolls 41A and 41B. The paper sheet fed by the feeding rolls 41A and 41B is transported along the first transporting path R1 or second transporting path R2, and third transporting path R3, and reaches the secondary transfer portion 30.

In the secondary transfer portion 30, by a secondary transfer electric field formed between a secondary transfer roll 31 and an opposing roll 32 which will be described later, the full-color toner image held on the intermediate transfer belt 20 is collectively and secondarily transferred to the paper sheet.

After this, the paper sheet to which the full-color toner image is transferred is separated from the intermediate transfer belt 20, and transported to the fixing machine 60 along the fourth transporting path R4. The full-color toner image on the paper sheet transported to the fixing machine 60 is subjected to fixing processing by the fixing machine 60, and fixed onto the paper sheet. In addition, the paper sheet on which the fixed image is formed is cooled by the condenser 70, and the curve of the paper sheet is corrected by the curl correction device 80. After this, the paper sheet which passed through the curl correction device 80 is guided to the fifth transporting path R5 when simplex printing is performed, and transported to the paper sheet loading portion 44, by the sorting mechanism portion 43.

In addition, respectively, the toner (residual toner after the primary transfer) which is attached to the photosensitive drum 12 after the primary transfer is removed by the drum cleaner 16, and the toner (residual toner after the secondary transfer) which is attached to the intermediate transfer belt 20 after the secondary transfer is removed by the belt cleaner 23.

Meanwhile, when duplex printing is performed, after the paper sheet on which the fixed image is formed on the first surface of the paper sheet according to the above-described process is guided to the sixth transporting path R6 by the sorting mechanism portion 43 after passing through the curl correction device 80, and is transported to the intermediate paper sheet accommodation container 42 via the sixth transporting path R6. Again, the feeding roll 45 rotates in accordance with the initiating timing of the image forming on a second surface of the paper sheet by each image forming unit 11, and the paper sheet from the intermediate paper sheet accommodation container 42 is fed. The paper sheet fed by the feeding roll 45 is transported along the seventh transporting path R7 and the third transporting path R3, and reaches the secondary transfer portion 30.

In the secondary transfer portion 30, similarly to a case of the first surface, the full-color image on the second surface held on the intermediate transfer belt 20 is collectively and secondarily transferred to the paper sheet by the secondary transfer electric field formed between the secondary transfer roll 31 and the opposing roll 32.

In addition, similarly to a case of the first surface, the paper sheet to which the toner image is transferred on both surfaces is fixed by the fixing machine 60, and cooled by the condenser 70, and further, the curve of the paper sheet is corrected by the curl correction device 80. After this, the paper sheet which passed through the curl correction device 80 is guided to the fifth transporting path R5 by the sorting mechanism portion 43, and transported to the paper sheet loading portion 44.

In this manner, the image forming operation in the image forming apparatus 1 is repeatedly performed only by a cycle as much as the number of prints.

Description of Developer

Next, the developer which is used in the exemplary embodiment will be described.

Each of the developer which is used in the exemplary embodiment includes the magnetic carrier and the toner colored by each color. In addition, the developer reduces a frictional force which is generated between the photosensitive drum 12 and the drum cleaner 16, and includes a cleaning agent which prevents the photosensitive layer provided on the photosensitive drum 12 from being worn out. Furthermore, the developer includes an external additive.

As the carrier included in the developer, it is possible to use, for example, a carrier in which a coating layer made of a resin or the like is formed on magnetic core particles. Examples of the core particles of the carrier include a ferromagnetic metal (e.g., iron, cobalt, and nickel), an alloy (e.g., magnetite, hematite, and ferrite), and a compound thereof.

In addition, as a resin for forming the coating layer of the carrier, a polyolefin resin, an acrylic resin, a silicone resin, a polyvinylidene resin, a fluorocarbon resin, an amino resin, or an epoxy resin, may be employed.

The toners (hereinafter, simply referred to as a toner of ordinary color) of the developers of ordinary colors used in the image forming units 11Y, 11M, 11C, and 11K of ordinary colors, include a coloring agent of various colors, such as yellow, magenta, cyan, and black, a binder resin, and an external additive.

In addition, the toners (hereinafter, simply referred to as a toner of metallic color) of the developers of metallic colors used in the image forming units 11G and 11S of metallic colors include a metallic pigment instead of the coloring agent in the toner of ordinary color, or in addition to the coloring agent in the toner of ordinary color.

Examples of the metallic pigment used in the toner of metallic color include pigment which show metallic luster and contains metal, such as metal powder (e.g., aluminum, brass, bronze, nickel, stainless steel, and zinc), coating flake-like inorganic crystal substrate (e.g., mica coated with titanium oxide or yellow iron oxide, barium sulfate, layered silicate, or silicate of layered aluminum), single crystal plate-shaped titanium oxide, basic salt carbonate, acid bismuth oxychloride, or metal-deposited flake-like glass powder. The metallic pigment is conductive.

Description of Developing Device

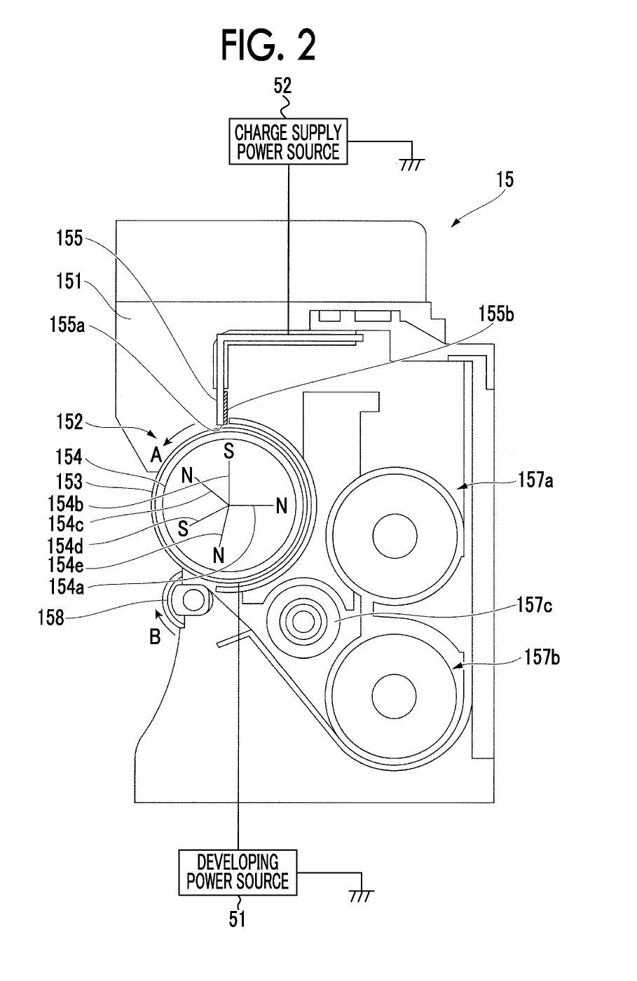

Next, a configuration of the developing device 15 will be described. FIG. 2 is a view illustrating a configuration example of the developing device 15 in which the exemplary embodiment is employed.

The developing device 15 includes a developing housing 151 and a developing roll 152 which is an example of a developer holding member. The developing housing 151 has an opening formed therein at a position which opposes an outer circumferential surface of the photosensitive drum 12 (refer to FIG. 1), and accommodates the developer (not illustrated) which includes the carrier and the toner inside thereof. The developing roll 152 is disposed at a location facing the opening of the developing housing 151.

In addition, the developing device 15 includes a first agitating and transporting member 157a, a second agitating and transporting member 157b, and a third agitating and transporting member 157c. Here, the first agitating and transporting member 157a, the second agitating and transporting member 157b, and the third agitating and transporting member 157c are disposed below a rear surface of the developing roll 152 when viewed from the photosensitive drum 12. In addition, the first agitating and transporting member 157a, the second agitating and transporting member 157b, and the third agitating and transporting member 157c are disposed along an axial direction of the photosensitive drum 12. In addition, between the first agitating and transporting member 157a and the second agitating and transporting member 157b, a partition wall which is provided in the developing housing 151 and partitions both members, is provided. In the developing device 15, the developer circulates and is transported inside the developing housing 151 by the first agitating and transporting member 157a, the second agitating and transporting member 157b, and the third agitating and transporting member 157c.

Furthermore, the developing device 15 includes a layer thickness regulating member 155 as an example of an opposing member or a charge imparting member. The layer thickness regulating member 155 is disposed at an upper part of the drawing of the developing roll 152. Here, a void is formed between an outer circumferential surface of the developing roll 152 and a tip end portion of the layer thickness regulating member 155. The void between the outer circumferential surface of the developing roll 152 and the tip end portion of the layer thickness regulating member 155 may have a range of 0.5 mm to 0.8 mm, for example. In addition, the layer thickness regulating member 155 regulates the thickness of the layer of the developer attached to the developing roll 152.

Furthermore, the developing device 15 includes a seal roll 158. A front surface of the seal roll 158, for example, is configured of nonmagnetic SUS, and the seal roll 158 is disposed via the void set in advance with respect to the outer circumferential surface of the developing roll 152. In this example, the void between the outer circumferential surface of the developing roll 152 and the outer circumferential surface of the seal roll 158 is approximately 1 mm. In addition, the seal roll 158 is rotated in a direction (arrow B direction) opposite to a rotating direction (arrow A direction) of a developing sleeve 153 which will be described later of the developing roll 152 by a driving device which is not illustrated.

In addition, the seal roll 158 suctions and collects toner cloud which is generated to be closer to a downstream side in the rotating direction of the developing roll 152 (developing sleeve) than a part where the developing roll 152 and the photosensitive drum 12 oppose each other.

The developing roll 152 includes the developing sleeve 153 and a magnetic roll 154.

Here, the developing sleeve 153 is formed in a cylindrical shape, and is disposed to be rotatable in the arrow A direction by the driving device which is not illustrated. in addition, a developing power source 51 which supplies developing bias is connected to the developing sleeve 153.

The magnetic roll 154 is formed in a columnar shape, and is disposed on an inner side of the developing sleeve 153, and fixed and attached to the developing housing 151.

The magnetic roll 154 has plural magnets. Specifically, in the magnetic roll 154, a drawing-up pole 154a which draws up the developer from the developing housing 151, a layer regulating pole 154b which regulates the thickness of the layer of the developer together with the layer thickness regulating member 155, a developing pole 154c which migrates and develops the toner in the photosensitive drum 12, a transporting pole 154d which transports the developer, and a peeling pole 154e which peels off the developer from the developing roll 152, are disposed in order in a circumferential direction.

In this example, the drawing-up pole 154a is disposed at a position which opposes the first agitating and transporting member 157a, the layer regulating pole 154b is disposed at a position which opposes the layer thickness regulating member 155, and the developing pole 154c is disposed at a position which opposes the photosensitive drum 12. In addition, the peeling pole 154e is disposed to be closer to an upstream side in the rotating direction of the developing sleeve 153 than the drawing-up pole 154a, and the transporting pole 154d is disposed at a position between the peeling pole 154e and the developing pole 154c in the circumferential direction.

In this example, the drawing-up pole 154a, the developing pole 154c, and the peeling pole 154e have N polarity, and the layer regulating pole 154b and the transporting pole 154d have S polarity.

In addition, the layer thickness regulating member 155 of the exemplary embodiment includes a conductive plate 155a which is made of a conductive member, such as SUS, and a magnetic plate 155b which is made of a magnetic member attached to the upstream side in the rotating direction of the developing roll 152 with respect to the conductive plate 155a. In this example, the thickness of the conductive plate 155a is approximately 1 mm, and the thickness of the magnetic plate 155b is 0.1 mm.

Although it will be described in detail later, a charge supply power source 52 as an example of a potential imparting unit which applies the charge supply bias for supplying the charge to the toner, is connected to the conductive plate 155a in the developing device 15 of the image forming units 11G and 11S of metallic color. In this example, the charge supply power source 52 is provided independently from the developing power source 51.

Description of Developing Operation.

Next, the developing operation by the developing device 15 will be described.

In the developing device 15, the first agitating and transporting member 157a, the second agitating and transporting member 157b, and the third agitating and transporting member 157c rotate as the driving force is transmitted, and the agitation and transportation of the developer is performed inside the developing housing 151. By the agitation and the transportation, as the toner and the carrier which configure the developer produce friction against each other, respectively, the toner is charged as negative polarity, and the carrier is charged as positive polarity. As a result, in the agitated and transported developer, the toner with respect to the carrier is in a state of being electrostatically suctioned. In addition, when the agitated and transported developer reaches a portion opposing to the developing roll 152, a part of the carrier is migrated to the developing roll 152 side due to the magnetic force which is generated between the drawing-up pole 154a provided in the magnetic roll 154 and the carrier included in the developer. At this time, since the toner is electrostatically suctioned to the migrating carrier, as a result, the developer is migrated to the developing roll 152 side. Accordingly, a developer layer made of the developer is formed on an outer circumferential surface of the developing sleeve 153.

In addition, in the developing device 15, the developing sleeve 153 rotates according to the transmission of the driving force. Accordingly, the developer layer formed on a developing sleeve 152a is transported according to the rotation of the developing sleeve 153. In addition, the thickness of the developer layer on the developing sleeve 153 is regulated by a magnetic field generated between the developing roll 152 and the magnetic plate 155b of the layer thickness regulating member 155 by the layer regulating pole 154b when passing through a portion opposing to the layer thickness regulating member 155, and the developing layer is carried to the opening of the developing housing 151 opposing the developing roll 152. In addition, the developer regulated by the layer thickness regulating member 155 returns to the first agitating and transporting member 157a side due to gravity. In addition, when passing through the portion opposing to the layer thickness regulating member 155, pressure due to packing is applied to the developer on the developing sleeve 153. For this reason, the toner which passed through the portion is further charged by the friction with the carrier.

Here, in the developing device 15, the developing bias set in advance as a developing bias is applied to the developing sleeve 153 from the developing power source 51.

Accordingly, in a developing region in which the photosensitive drum. 12 and the developing roll 152 (developing sleeve 153) oppose each other, the toner is electrostatically migrated from the developer layer on the developing sleeve 153 to the image portion on the photosensitive drum 12, and the electrostatic latent image is developed and visualized.

After this, the developer layer on the developing sleeve 153 which passed through the developing region is returned to the inside of the developing housing 151 according to the rotation of the developing sleeve 153. In addition, the developer layer on the developing sleeve 153 which is returned to the inside of the developing housing 151 is disengaged from above the developing roll 152 and falls to the inside the developing housing 151 due to a repulsive magnetic field formed by the peeling pole 154e provided in the magnetic roll 154, is agitated and transported by the first agitating and transporting member 157a, the second agitating and transporting member 157b, and the third agitating and transporting member 157c again, and is on standby until the next development.

Description of Task of a Case where Toner of Metallic Color is Used

As described above, the image forming apparatus 1 of the exemplary embodiment may forma full-color image which has six colors in total, including four ordinary colors and two metallic colors, in addition to the full-color image having four ordinary colors. In addition, in the image forming apparatus 1 of the exemplary embodiment, the toners of each color are sequentially transferred onto the intermediate transfer belt 20, and the toner images of each color superposed and transferred onto the intermediate transfer belt 20 are collectively transferred to the paper sheet which is a transfer medium. For this reason, it is important to control a charged quantity of the toner used and the distribution thereof for improving the properties of the image or for preventing the defect of the image.

The toner of metallic color which is used by the image forming units 11G and 11S of metallic color includes the metallic pigment as described above. There are many cases where the metallic pigment included in the toner of metallic color have a larger particle diameter than that of the coloring pigment or the like which are used in the toner of ordinary color, and the shape thereof is nonspherical, for example, a shape of a flat plate or a flat shape. In addition, in the toner of metallic color, a content ratio, or a contained aspect of the metallic pigments in each of the toner particles are uniform, and a particle diameter, a shape of the toner particles and the like are uniform. For this reason, the toner of metallic color is likely to have a wider distribution in a charging function or a charge injection function under a high voltage than that of the toner of ordinary color.

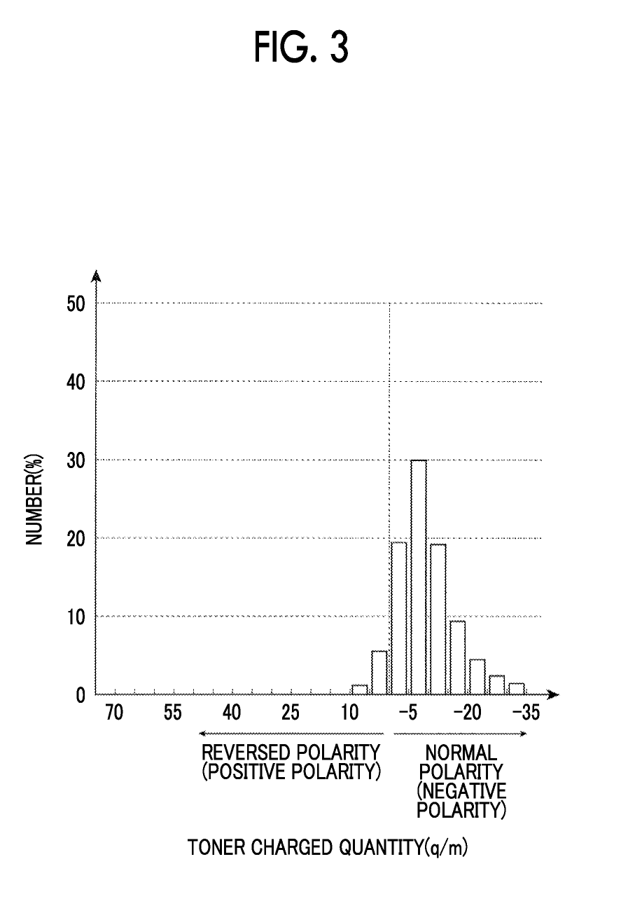

FIG. 3 is a view illustrating charged quantity distribution of the toner of metallic color on the developer layer formed on the developing sleeve 153, in the developing device 15 of the image forming units 11G and 11S of metallic color.

In the developing device 15 of the exemplary embodiment, the toner is mainly charged as negative polarity by the agitation and transportation inside the developing housing 151. Accordingly, as illustrated in FIG. 3, the toner in the developing device 15 of the image forming units 11G and 11S of metallic color has charged quantity distribution which shows a peak on a negative polarity side.

However, as the charging function of the toner of metallic color has wide distribution as described above, as illustrated in FIG. 3, the toner (hereinafter, referred to as a reversely charged toner) which is charged as reversed polarity (positive polarity) which is reversed to normal polarity (negative polarity), or the toner (hereinafter, referred to as a normal low-charged toner) which is charged as normal polarity (negative polarity) and has a low charged quantity, exists.

In addition, since the metallic pigment included in the toner of metallic color are conductive, the toner of metallic color is likely to be injected by the charges under a high voltage compared to the toner of ordinary color. In other words, the toner of metallic color is likely to be injected by the charges via the metallic pigment which is exposed to front surfaces of the toner particles, for example.

For this reason, for example, when the normal low-charged toner included in the toner of metallic color is migrated to the photosensitive drum 12, and reaches the portion opposing to the primary transfer roll 21, there is a case where the normal low-charged toner is charged by the primary transfer bias which is generated between the photosensitive drum 12 and the primary transfer roll 21, and becomes the reversely charged toner in which the polarity is reversed.

Furthermore, there is a concern that the reversely charged toner in which the polarity is reversed by the primary transfer bias remains in the photosensitive drum 12, and reversely transferred to the photosensitive drums 12 of the image forming unit 11 of other colors after being migrated to the intermediate transfer belt 20.

Specifically speaking, for example, the toner of gold color which is transferred to the intermediate transfer belt 20 in the image forming unit 11G of gold color (G) comes into contact with the photosensitive drums 12 of the image forming units 11S, 11Y, 11M, 11C, and 11K of silver (S), yellow (Y), magenta (M), cyan (C), and black (K). At this time, the reversely charged toner included in the toner of gold color is reversely transferred to each of the photosensitive drums 12, by the primary transfer bias which is generated between each of the photosensitive drums 12 and the primary transfer roll 21.

The reversely charged toner attached to the photosensitive drum. 12 is removed from the photosensitive drum 12 by the drum cleaner 16. However, since the reversely charged toner has reversed polarity which is reversed to that of the toner which is normally charged, it is difficult to completely remove the reversely charged toner from the front surface of the photosensitive drum. 12 by the drum cleaner 16. Therefore, on the front surfaces of each photosensitive drums 12, the remaining reversely charged toner that is not removed by the drum cleaner 16 is deposited.

In addition, there is a concern that the reversely charged toner deposited on the front surface of the photosensitive drum 12 is attached to a non-image portion of the intermediate transfer belt 20 and contaminates the image, or the reversely charge toner is flaked from the front surface of the photosensitive drum 12 and is attached to other members inside the image forming apparatus 1.

Regarding Application of Charge Supply Bias with Respect to Layer Thickness Regulating Member

To address this, in the developing device 15 of the exemplary embodiment, by applying the charge supply bias for supplying the charges to the reversely charged toner or the normally low-charged toner with respect to the layer thickness regulating member 155 by the charge supply power source 52, generation of the reversely charged toner is prevented.

Specifically speaking, in the exemplary embodiment, the charge supply bias having the same polarity as the normally charged polarity (negative polarity) of the toner is applied by the charge supply power source 52 to the conductive plate 155a of the layer thickness regulating member 155. Accordingly, the conductive plate 155a of the layer thickness regulating member 155 of the exemplary embodiment becomes negative potential.

Accordingly, as the toner which passes through the void between the developing roll 152 and the conductive plate 155a of the layer thickness regulating member 155 comes into contact with the conductive plate 155a, negative charges are received from the conductive plate 155a via the conductive metallic pigment included in the toner. In other words, negative charges which have the same polarity as the normally charged polarity of the toner is supplied to the toner from the conductive plate 155a of the layer thickness regulating member 155.

In addition, for example, the polarity of the reversely charged toner included in the toner is reversed to the normal polarity (negative polarity) by receiving the negative charges from the layer thickness regulating member 155 (conductive plate 155a), and becomes the normally charged toner. In addition, the charged quantity of the low-charged toner included in the toner increases by receiving the negative charges from the layer thickness regulating member 155 (conductive plate 155a).

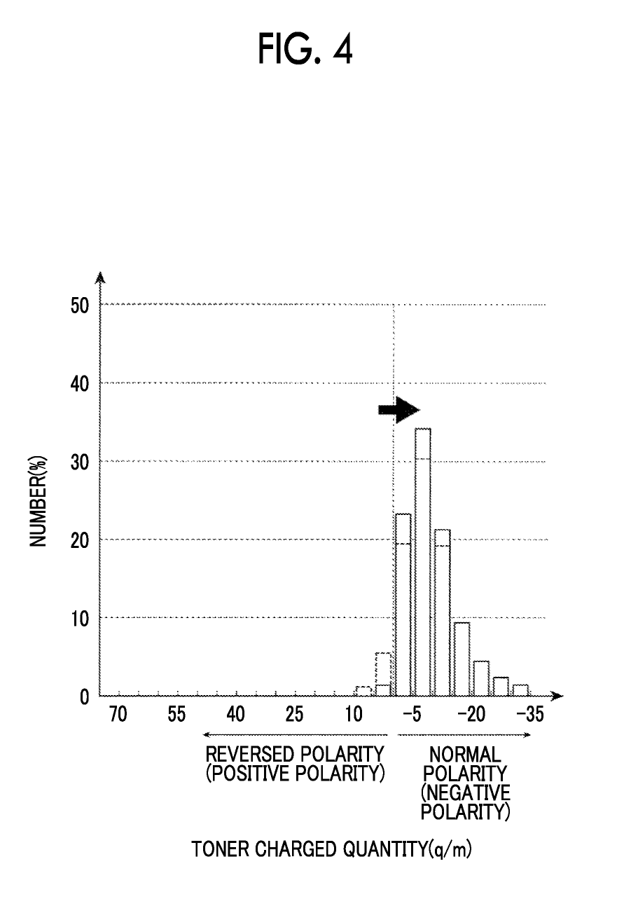

FIG. 4 is a view illustrating an action caused by the charge supply bias. In FIG. 4, the charged quantity distribution of the toner in the developer before passing through the layer thickness regulating member 155 is illustrated by a dashed line, and the charged quantity distribution of the toner in the developer after passing through the layer thickness regulating member 155 is illustrated by a solid line.

As illustrated in FIG. 4, by applying the charge supply bias to the layer thickness regulating member 155, the negative charges are imparted to the reversely charged toner and the normal low-charged toner included in the toner of metallic color, and the charged quantity distribution of the toner is shifted to the negative polarity side as a whole.

In other words, as illustrated in FIG. 4, the reversely charged toner included in the toner of metallic color is reversed to the normal polarity and becomes the normally charged toner by the negative charges from the layer thickness regulating member 155. Furthermore, as illustrated in FIG. 4, the charged quantity of the normal low-charged toner increases by the negative charges from the layer thickness regulating member 155.

As a result, in the developing device 15, in the developer layer after passing through the developing roll 152 and the portion opposing to the layer thickness regulating member 155, an amount (number) of the reversely charged toner or the normal low-charged toner which is likely to be a reversely charged toner by the primary transfer bias or the like decreases.

In addition, in the exemplary embodiment, as the quantity of the reversely charged toner or the normal low-charged toner decreases, generation of contamination or the like of the image forming apparatus 1 or the paper sheet due to the attachment of the reversely charged toner to the photosensitive drum 12 and the flaking of the reversely charged toner attached to the photosensitive drum 12, is prevented.

As described above, in the developing device 15 of the exemplary embodiment, the void between the developing roll 152 and the layer thickness regulating member 155 is a void set in advance, and pressure due to packing is applied to the developer which passes through between the developing roll 152 and the layer thickness regulating member 155.

Accordingly, compared to a case where the configuration is not employed, the toner included in the developer which passes through between the developing roll 152 and the layer thickness regulating member 155 is likely to come into contact with the conductive plate 155a of the layer thickness regulating member 155, and it is possible to effectively impart the negative charges to the toner.

In addition, in the developing device 15 of the exemplary embodiment, the negative charges are also imparted by the conductive plate 155a of the layer thickness regulating member 155, to a normal high-charged toner which is sufficiently charged as the normal polarity, in addition to the reversely charged toner and the normal low-charged toner included in the developer. However, the toner of metallic color of the exemplary embodiment includes the conductive metallic pigment, and have properties that the charges are likely to leak compared to the toner of ordinary color.

Therefore, even when the negative charges are imparted to the normal high-charged toner by the conductive plate 155a of the layer thickness regulating member 155, the problem that the charged quantity of the entire toner becomes too high is unlikely to be generated.

Here, it is preferable that an absolute value of potentials of the conductive plate 155a of the layer thickness regulating member 155 is greater than an absolute value of potentials of the developing sleeve 153 to which the developing bias is applied by the developing power source 51. By making the absolute value of the potentials of the conductive plate 155a of the layer thickness regulating member 155 greater than the absolute value of the potentials of the developing sleeve 153, the reversely charged toner included in the developer is likely to move to the conductive plate 155a side due to the electric field which is generated between the conductive plate 155a and the developing sleeve 153, and it is possible to effectively impart the negative charges to the reversely charged toner.

In the developing device 15 of the exemplary embodiment, the developing bias set in advance is applied to the developing sleeve 153 of the developing roll 152 by the developing power source 51. In this example, as the developing bias, for example, a superposed bias, which is made by superposing AC developing bias having 1 kV of a peak-to-peak voltage on DC developing bias having −500 V, is applied as the developing bias. Therefore, it is preferable to apply the charge supply bias by the charge supply power source 52 so that the surface potential of the conductive plate 155a of the layer thickness regulating member 155 becomes lower than −500 V.

### Second Exemplary Embodiment

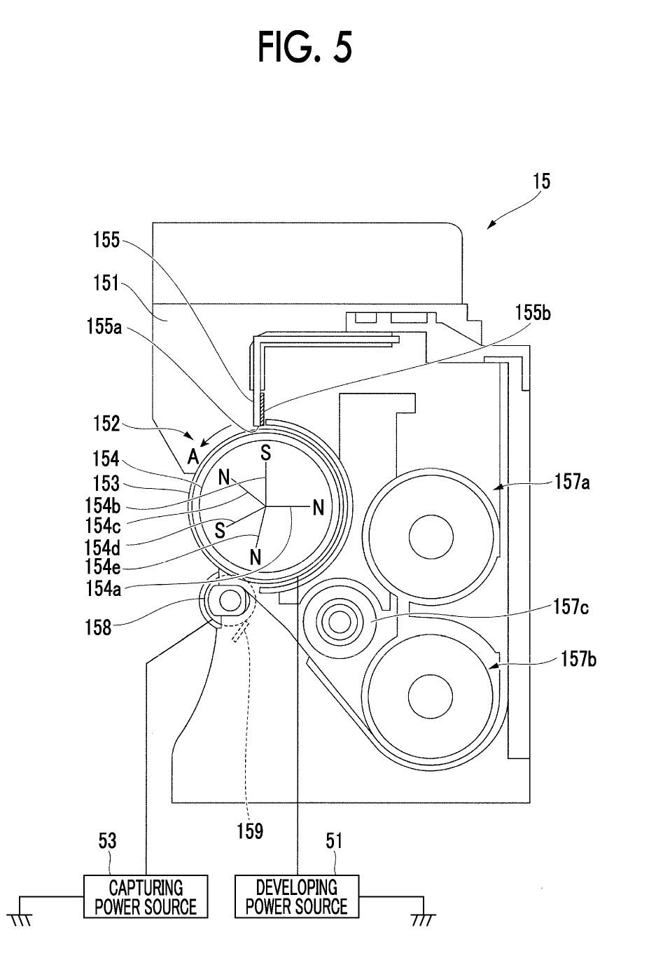

Next, a second exemplary embodiment will be described. FIG. 5 is a view illustrating a configuration example of the developing device 15 in which the second exemplary embodiment is employed. In addition, configurations similar to that of the first exemplary embodiment use the similar reference numerals, and here, detailed description thereof will be omitted.

As described above, in the first exemplary embodiment, by applying the charge supply bias to the layer thickness regulating member 155 which is positioned to be closer to the upstream side in the rotating direction of the developing roll 152 (developing sleeve 153) than the position where the developing roll 152 and the photosensitive drum. 12 oppose each other, generation of the reversely charged toner in the toner of metallic color is prevented. In contrast to this, in the second exemplary embodiment, by applying capturing bias having the polarity set in advance to the seal roll 158 which is an example of an opposing member or a capturing member positioned to be closer to the downstream side in the rotating direction of the developing roll 152 (developing sleeve 153) than the potion where the developing roll 152 and the photosensitive drum 12 oppose each other, generation of the reversely charged toner in the toner of metallic color is prevented.

As illustrated in FIG. 5, in the developing device 15 of the image forming units 11G and 11S of metallic color in the second exemplary embodiment, a capturing power source 53 which is an example of a potential imparting unit that applies the capturing bias for capturing the reversely charged toner attached to the developing roll 152 is connected to the seal roll 158. In this example, the capturing power source 53 is provided independently from the developing power source 51.

In addition, the developing device 15 of the exemplary embodiment is provided to come into contact with the outer circumferential surface of the seal roll 158, and includes a scraping member 159 which scrapes the toner attached to the front surface of the seal roll 158.

In the exemplary embodiment, the capturing bias which has the same polarity as the normally charged polarity (negative polarity) of the toner, and has the absolute value of the potentials of the front surface of the seal roll 158, which is greater than the absolute value of the potentials of the front surface of the developing roll 152 (developing sleeve 153), is supplied to the seal roll 158 by the capturing power source 53.

As described above, the superposed bias which is made by superposing AC developing bias having 1 kV of a peak-to-peak voltage on DC developing bias having −500 V, is applied to the developing roll 152 (developing sleeve 153) as the developing bias. Therefore, in the exemplary embodiment, the capturing bias is applied to the seal roll 158 by the capturing power source 53 so that the surface potential of the seal roll 158 becomes lower than −500 V.

The electric field which is towards the seal roll 158 side from the developing roll 152 side is formed by the capturing bias which is supplied by the capturing power source 53, between the seal roll 158 and the developing roll 152. In addition, in the developing device 15 of the exemplary embodiment, due to the action of the electric field formed between the seal roll 158 and the developing roll 152, the reversely charged toner having the positive polarity which is attached to the front surface of the developing sleeve 153 and included in the developer moves to the seal roll 158 side, and is captured by the seal roll 158.

The reversely charged toner captured on the front surface of the seal roll 158 is scraped from the front surface of the seal roll 158 by the scraping member 159 after moving to a portion opposing the scraping member 159 according to the rotation of the seal roll 158. The reversely charged toner scraped from the front surface of the seal roll 158 is transported to the outside of the developing device 15 by a transporting unit which is not illustrated, and is removed.

In this manner, in the developing device 15 of the exemplary embodiment, by capturing the reversely charged toner attached to the developing roll 152 in the developer by the seal roll 158, it is possible to reduce the quantity of the reversely charged toner included in the developer accommodated in the developing housing 151.

As a result, in the exemplary embodiment, generation of contamination or the like of the image forming apparatus 1 or the paper sheet due to the attachment of the reversely charged toner to the photosensitive drum 12 and the flaking of the reversely charged toner attached to the photosensitive drum 12, is prevented.

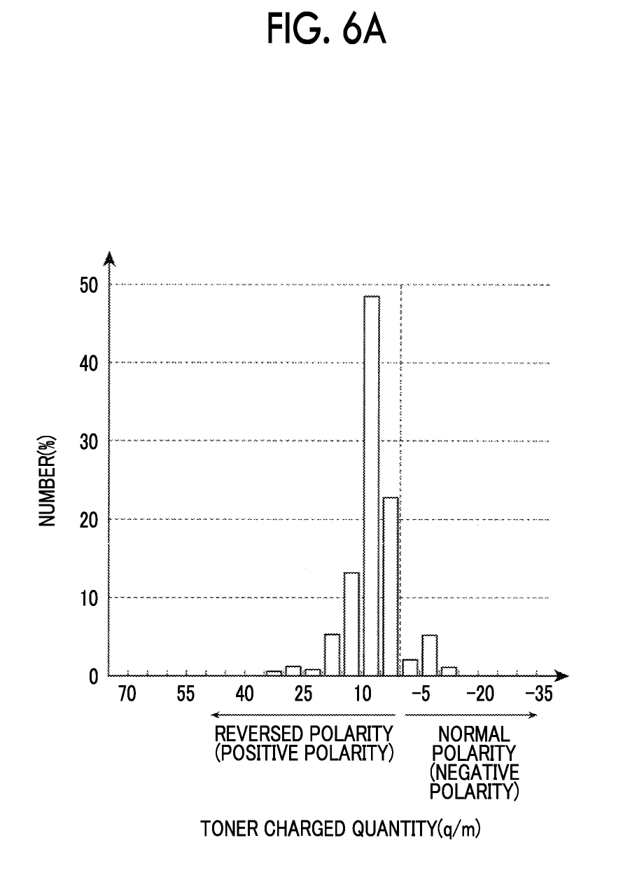

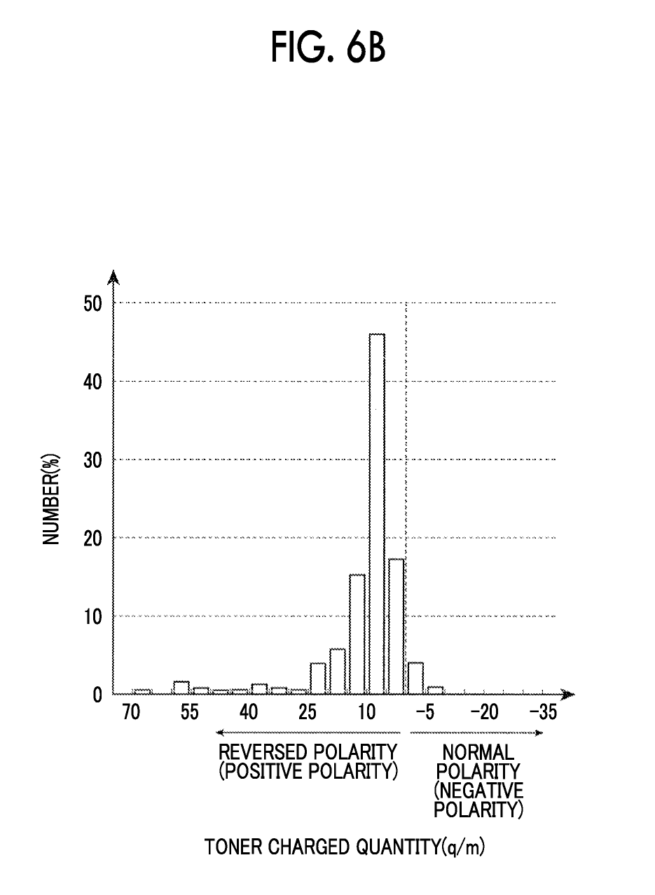

FIGS. 6A to 6B are views illustrating charged quantity distribution of a toner captured by the seal roll 158. Here, FIG. 6A is the charged quantity distribution of the toner in a case where −500 V of voltage is applied as the developing bias by the developing power source 51 to the developing sleeve 153 of the developing roll 152, and −600 V of voltage is applied as the capturing bias by the capturing power source 53 to the seal roll 158. In addition, FIG. 6B is the charged quantity distribution of the toner in a case where −500 V of voltage is applied as the developing bias by the developing power source 51 to the developing sleeve 153 of the developing roll 152, and −700 V of voltage is applied as the capturing bias by the capturing power source 53 to the seal roll 158.

As illustrated in FIGS. 6A and 6B, by applying the capturing bias by the capturing power source 53 to the seal roll 158, it is confirmed that the reversely charged toner which has a reversed polarity (positive polarity) which is reversed to the normal polarity (negative polarity) on the front surface of the seal roll 158 may be effectively captured.

In addition, when comparing FIGS. 6A and 6B to each other, in a case of FIG. 6B where a difference in surface potentials between the developing roll 152 (developing sleeve 153) and the seal roll 158 is large, it is confirmed that the content of the reversely charged toner in the captured toner is large.

Therefore, by applying the capturing bias by the capturing power source 53 so that the absolute value of the surface potentials of the seal roll 158 is greater than the absolute value of the surface potentials of the developing roll 152 (developing sleeve 153), the reversely charged toner is selectively captured from the developer attached to the developing sleeve 153.

In addition, in the exemplary embodiment, the superposed bias which is made by superposing the AC bias on the DC bias by the capturing power source 53 may be applied to the seal roll 158 as the capturing bias. In this case, for example, compared to a case where only the DC bias is applied as the capturing bias, it is possible to further accelerate the movement of the reversely charged toner to the seal roll 158 from the developing sleeve 153.

In addition, here, the developing device 15 of the first exemplary embodiment which supplies the charge supply bias to the layer thickness regulating member 155, and the developing device 15 of the second exemplary embodiment which supplies the capturing bias to the seal roll 158, are separately described, but both the developing devices 15 in the first exemplary embodiment and the second exemplary embodiment may be used together.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device, comprising:
a developer holding member that is rotatably disposed with opposing a latent image holding member which holds an electrostatic latent image, holds a developer including a toner and a carrier which include a conductive metallic pigment and are charged as normal polarity set in advance, is imparted with a potential of a same polarity as the normal polarity, and develops the electrostatic latent image with the toner; and
an opposing member that is disposed with opposing the developer holding member at a position different from a position of the latent image holding member, is imparted with a potential having a same polarity as the normal polarity, and has an absolute value greater than an absolute value of the potential of the developer holding member.

2. The developing device according to claim 1,
wherein the opposing member is disposed on an upstream side, in a rotating direction of the developer holding member, of a portion where the developer holding member and the latent image holding member oppose each other, and regulates thickness of the developer held on a surface of the developer holding member.

3. The developing device according to claim 1,
wherein the opposing member is disposed on a downstream side, in a rotating direction of the developer holding member, of a portion where the developer holding member and the latent image holding member oppose each other, and captures the toner attached to a surface of the developer holding member.

4. A developing device, comprising:
a developer holding member that is rotatably disposed with opposing a latent image holding member which holds an electrostatic latent image, holds a developer including a toner and a carrier which include a conductive metallic pigment and are charged as normal polarity set in advance, and develops the electrostatic latent image with the toner; and
a charge imparting member that is disposed on an upstream side, in the rotating direction of the developer holding member, of a portion where the developer holding member and the latent image holding member oppose each other, and imparts a potential having a same polarity as the normal polarity to the toner.

5. The developing device according to claim 4,
wherein the charge imparting member is imparted with a potential having the same polarity as the normal polarity, and has an absolute value greater than an absolute value of the potential of the developer holding member.

6. The developing device according to claim 4,
wherein the charge imparting member is disposed with opposing an outer circumferential surface of the developer holding member via a distance set in advance, and regulates thickness of the developer held on a surface of the developer holding member.

7. The developing device according to claim 5,
wherein the charge imparting member is disposed with opposing an outer circumferential surface of the developer holding member via a distance set in advance, and regulates thickness of the developer held on a surface of the developer holding member.

8. A developing device, comprising:
a developer holding member that is rotatably disposed with opposing a latent image holding member which holds an electrostatic latent image, holds a developer including a toner and a carrier which include a conductive metallic pigment and are charged as normal polarity set in advance, and develops the electrostatic latent image with the toner; and
a capturing member that is disposed on a downstream side, in a rotating direction of the developer holding member, of a portion where the developer holding member and the latent image holding member oppose each other, and captures a toner charged as polarity reversed to the normal polarity from a surface of the developer holding member.

9. The developing device according to claim 8,
wherein the capturing member is imparted with a potential having a same polarity as the normal polarity and having an absolute value greater than an absolute value of a polarity of the developer holding member.

10. The developing device according to claim 9,
wherein superposed bias obtained by superposing DC bias and AC bias on each other is applied to the capturing member.

11. The developing device according to claim 7, further comprising:
a scraping member that is disposed in contact with the surface of the capturing member, and scrapes the toner captured by the capturing member.

12. The developing device according to claim 8, further comprising:
a scraping member that is disposed in contact with the surface of the capturing member, and scrapes the toner captured by the capturing member.

13. The developing device according to claim 9, further comprising:
a scraping member that is disposed in contact with the surface of the capturing member, and scrapes the toner captured by the capturing member.
